(19) United States
(12) Patent Application Publication
(10) Pub. No.: US 2007/0022178 A1
(43) Pub. Date: Jan. 25, 2007

(54) Systems and methods for adding media from a content input device into a loop

(76) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(21) Appl. No.: 11/478,951

(22) Filed: Jun. 30, 2006

Related U.S. Application Data
(60) Provisional application No. 60/696,375, filed on Jul. 1, 2005.

(51) Int. Cl. G06F 15/16

(52) U.S. Cl. 709/217

(57) ABSTRACT

A system and method for providing a media to a media engine from a remote location comprises a digital recorder, a user interface for receiving a selection of the media to be added to a first loop, a processor for generating an instruction comprising a copy of the media and indicating the first loop, and a communication interface for transmitting the instruction to a media engine. The system and method for distributing the media comprises a media engine for receiving the instruction from a content input device and processing the instruction to determine a loop identifier using the unique identifier, determine a first loop to add the media to using the loop identifier, and add the media to the first loop.

### CROSS-REFERENCE

This United States nonprovisional patent application claims the benefit of U.S. provisional patent application No. 60/696,375 filed Jul. 1, 2005 and entitled “Systems and Methods for Digital Camera Input into a Loop,” which is hereby incorporated by reference.

### BACKGROUND OF THE INVENTION

1. Field of the Invention

This invention relates generally to distribution of digital media and more specifically to adding media from a content input device into a loop.

2. Description of the Related Art

In the modern electronic age, many people are accustomed to exchanging data in various manners. Users of computing devices share information via personal digital assistants (PDAs), mobile telephones (e.g., cell phones), laptop computers, and so on, for example. Information in the form of media is frequently shared among users to present visual and/or audio media to each other.

Currently, if a user wishes to share photos of a newborn baby taken at the hospital the hospital, the user is unable to transmit the photos while at the hospital. The user must take the photos on a digital camera, then go home to plug the digital camera into the computer, download the photo into a file on the computer, and then find the file to post the photo on a website or email the photo to others.

If the user does not know how to post to a website or create a website, the user may use a photo sharing website on the Internet such as Snapfish® or Shutterfly®. These services, however, require users sign up for the service, log-in, enter email addresses of other users who can view the photos, and upload the photos onto their website. The uploading process may be confusing and slow, especially for multiple files and/or large image or video files. Further, the website may display a poorer quality image to the other users to save bandwidth or downloading time.

Emailing the photos from the computer may be just as cumbersome by requiring the user to log-in to an email program or account, individually attach the photos to an email message, address the email message, and then send the email message to others. The intended recipients of the photos may have out-of-date addresses and not receive the photos. Even if the email address is correct, the recipient may not have enough storage space available to accept the email message with the photos. This may require that the user resend the photos in a format with poorer image quality to some of the recipients.

Alternatively, a user can take a snapshot of the baby and send that snapshot to friends via the user's cell phone from the hospital. For instance, the user may access a file in a directory on the user's cell phone to locate the photo the user wishes to share with the other user. Once the user locates the photo, the user typically right clicks on the photo and selects an option, such as “send picture by electronic mail to”, in the case of an image. When the “send picture by electronic mail to” option is selected, an electronic mail window opens in which the user can enter text and select “send” to send the photo to the other user. Alternatively, the user may open an electronic mail window and attach the photo, or other type of media file, and send an electronic mail message along with the attachment to the other user. The process of sharing the photo can take several minutes, because of the number of steps involved in locating, addressing, and sending the media to specified users. Again, the recipient's email address may have changed or the account may not have enough available memory to accept the message.

However, with the improved performance of contemporary computing devices, users expect immediacy in sending media. While computing devices' performance is at an all-time high, users still require fewer steps for performing certain tasks. Additionally, users want the ability to share media while using mobile devices such as mobile phones. Therefore, there is a need for a system and method for single act media during sharing from remote locations.

### SUMMARY OF THE INVENTION

A system for the distribution of a media comprises a communication interface and a processor. The communication interface receives an instruction from a content input device. The instruction comprises a media. The processor processes the instruction to determine a loop identifier. The processor next determines a first loop to add the media in the instruction to using the loop identifier. The processor adds the media to the first loop.

The instruction may also comprise a user identifier which may be associated with a default loop. The communication interface may transmit a list comprising the loop identifier to the content input device. The processor may be configured to create the first loop.

A method for distributing a media comprises receiving an instruction from a content input device. The instruction comprises a media. Next, the instruction is processed to determine a loop identifier. The method then comprises determining a first loop to add the media to using the loop identifier and adding the media to the first loop.

A software product for distributing media comprises software operational when executed by the processor and a storage medium configured to store the software. The software, when executed, directs the processor to receive an instruction from a content input device. The instruction comprises a media. Next, to process the instruction to determine a loop identifier. The software then directs the processor to determine a first loop to add the media to using the loop identifier and add the media to the first loop.

A system for providing media comprises a digital recorder, a user interface, a processor and a communication interface. The digital recorder captures the media. The user interface receives a selection indicating that the media is to be added to the first loop. The processor generates an instruction comprising the media and indicating the first loop. The communication interface transmits the instruction to a media engine.

The user interface may display a loop menu according to a list comprising the loop identifier received from the media engine. The instruction may indicate a user identifier that may be associated with a default loop. The instruction may indicate a command to create the first loop.

A method for providing media comprises capturing the media. Next, a selection is received from a user indicating that the media is to be added to the first loop. The method then comprises generating an instruction comprising a copy of the media and indicating the first loop. The instruction is then transmitted to the media engine.

A software product for providing media comprises software operational when executed by the processor and a storage medium configured to store the software. The software, when executed, directs the processor to capture the media and receive a selection of the media. The selection indicates that the media is to be added to a first loop. The software, when executed, directs the processor to generate an instruction comprising a copy of the media and indicating the first loop. The instruction is then transmitted to a media engine.

### BRIEF DESCRIPTION OF THE DRAWINGS

FIG. 1 illustrates an exemplary environment for providing single act media sharing in accordance with one embodiment.

FIG. 2A illustrates an exemplary diagram for a media engine within a client in accordance with one embodiment.

FIG. 2B illustrates a block diagram of a client in accordance with one embodiment of the invention.

FIG. 3 illustrates exemplary components associated with the server in accordance with one embodiment.

FIG. 4 illustrates an exemplary flow diagram for single act media sharing in accordance with one embodiment.

FIG. 5 illustrates another exemplary flow diagram for sharing media in response to the single act by the user in accordance with one embodiment.

FIG. 6 illustrates an exemplary graphical user interface in accordance with one embodiment.

FIG. 7 illustrates an exemplary screen shot of a loop in accordance with one embodiment.

FIG. 8 illustrates a block diagram of a content input device in accordance with one embodiment.

FIG. 9 illustrates an exemplary screen shot of a loop interface in accordance with one embodiment.

FIG. 10 illustrates an exemplary flow diagram for sharing media in response to the single act by the user at the content input device in accordance with one embodiment.

FIG. 11 illustrates an exemplary flow diagram for adding media to a loop in response to an instruction received from a content input device at the media engine.

### DESCRIPTION OF EXEMPLARY EMBODIMENTS

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

A method and content input device is described for adding media to a loop from a remote location by a user. The content input device may comprise a digital camera or voice recorder to generate the media. Upon receiving a selection of the media and, optionally, a selection of a loop from the user, the media is transmitted over a network to a media engine configured to add the media to a specific loop. The loop interface on the content input device permits convenient distribution of the media by decreasing the overall number of steps that the user is required to perform. By sending the media to a loop, the user no longer needs to email the media or post the media to a website.

A loop is provided for displaying media in association with a computing device related to a user. A loop is an automatically moving interactive display of a plurality of media. The media may be arranged consecutively. The user may select various media to display using the loop. In one embodiment, the loop comprises a Filmloop™. The loop may scroll the media across a display device associated with the computing device, or across any other display associated with any type of device. According to various embodiments, the media selected by the user for the loop may be shared with one or more other users at one or more other computing devices when the user drags the media to the loop, if the one or more other users share the same loop on their respective computing devices. Various other features associated with the loop are described herein.

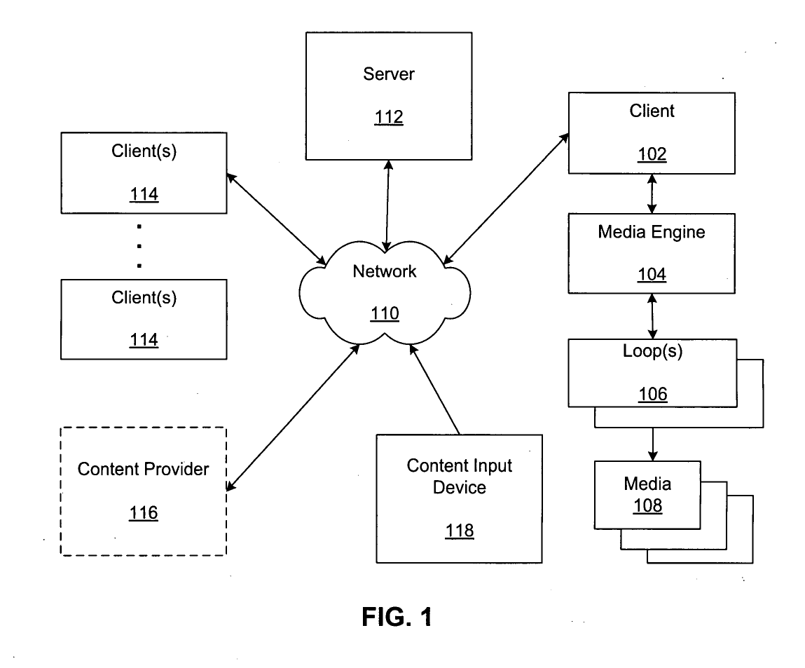

Referring to FIG.1, an exemplary environment for providing single act media sharing is shown. A user is associated with a client 102. The client 102 includes any type of computing device that is configured to construct, update and display a loop, such as a cellular telephone, a laptop computer, a personal digital assistant (PDA), and so on. The client 102 has a media engine 104 coupled to the client 102 for creating and/or generating at least one loop 106. The media engine 104 may also play the loop 106. A loop player comprises the graphical representation of the media engine 104.

The loop 106 may be comprised of various media 108. The media 108 can include photos, video, audio, images, text, advertisements, and/or any other type of media. The media 108 may appear as one or more items separated by lines, frames, or any other display item for defining the one or more items of the media 108 as separate from each other in the loop. Each frame of the media 108 may itself include moving displays, motion pictures, and so forth.

In one embodiment, the loop 106 scrolls, or is otherwise played, across a display associated with the client 102. In some embodiments, the loop 106 may be manipulated by a user of the client 102 to stop, speed up, or slow down the scrolling of the loop 106, and/or any other type of manipulation. The client 102 may have more than one loop 106 that scrolls across the display at one time. Further, the client 102 may have various loop(s) 106 that play at one time and/or are stored at the client 102 to be played at a time chosen by the user associated with the client 102. The user may also play more than one loop 106, such as playing the loops 106 sequentially, in a single media engine 104.

The media engine 104 may reside on the client 102 or may be otherwise coupled to the client 102. Alternatively, the media engine 104 may be accessible to the client 102 via a network, such as the network 110 shown in FIG. 1. For example, one or more clients 102 may access the media engine 104 via a network in order to create the loop(s) 106, update the loop(s) 106 with additional media 108, remove certain of the media 108 from the loop(s) 106, alter metadata associated with the loop(s) 106, modify the media 108 or metadata associated with the media 108 contained in the loop(s) 106, play the loop(s) 106, and/or perform any other functions utilizing the media engine 104.

In exemplary embodiments, the identifier assigned to the media 108 may be unique within the loop(s) 106. Further, the loop(s) 106 identifier and/or the media 108 identifier is unique within the network 110, according to exemplary embodiments. Any type of identifiers may be assigned to the loop(s) 106 and/or the media 108 according to various embodiments.

The media engine 104 may be utilized, as discussed herein, to create the loop(s) 106 using the media 108. Typically, the user at the client 102 selects the media 108 from files located on the client 102 and/or from media 108 available via the network 110. For example, the user may search for and provide photos found on the Internet to the media engine 104. Alternatively, the user may transmit media 108 from a content input device 118 to the media engine 104. The media engine 104 receives the media 108 and creates the loop(s) 106 with the media 108. The user can provide more than one item of the media 108 to the media engine 104 for creating or modifying loop(s) 106.

The user can provide the media 108 by dragging and dropping the media 108 into the media engine 104, by initiating a command that the media 108 be used to create a new loop(s) 106 and/or modify an existing loop 106, and/or any other method of identifying the media 108 as part of the loop(s) 106. In exemplary embodiments, the user can drag a folder including more than one item of the media 108 into the loop(s) 106. In other embodiments, a user can provide a copy of the media 108 by selecting a loop 106 or sending an instruction to create a new loop 106 at a content input device 118.

The media engine 104 may assign an identifier to each of the loop(s) 106. The media engine 104 may further assign an identifier to each of the media 108 in the loop 106. For example, the media engine 104 may assign an identifier to a loop 106 that is newly created and may also assign identifiers to each of the media 108 used to create the new loop 106. In one embodiment, the media 108 may receive the same or similar identifier as the loop 106 to which the media 108 belongs.

The loop(s) 106 may be stored by category, dates associated with the media 108 included in the loop(s) 106, metadata associated with the loop(s) 106, or any other criteria. The criteria may be provided to the user as a default and/or the user can specify criteria for storing and/or playing the loop(s) 106. For example, in one embodiment, the user may specify that the loop(s) 106 should be played one at a time, one per day, according to a particular subject matter (e.g. such as family photo loop(s) 106, followed by fan club loop(s) 106, followed by work oriented loop(s) 106), and so forth. Any method for playing the loop(s) 106 is within the scope of various embodiments.

When the user drags and drops one or more items of the media 108 into a particular loop 106, the user is requesting that the media engine 104 modify the particular loop(s) 106 by adding the one or more items of the media 108. The user may additionally request that the media engine 104 modify the particular loop(s) 106 by transmitting the media 108 and a loop(s) 106 selection from a content input device 118. Accordingly, the media engine 104 assigns an identifier that is unique within the loop 106 to each of the items of the media 108 dropped or transmitted by the user.

As discussed herein, the media 108 may be added to more than one loop(s) 106. Accordingly, the media 108 may have more than one identifier associated with the media 108 in order to identify the one or more loop(s) 106 which contain the media 108.

In order to add the media 108 to a loop 106 without using the drag and drop method, the user can identify the media 108 to be added and subsequently include the media 108 into the loop(s) 106 of the media engine 104. For example, the user may copy the media 108 from outside of the loop(s) 106. Subsequently, the user may paste the media 108 into the loop(s) 106. Alternatively, the user can select a loop 106 at a content input device 118 prior to transmitting a copy of the media 108 to the media engine 104. The user can identify the loop 106 according to the identifier of the loop 106, by subject matter, and/or by any other criteria that indicates to the media engine 104 which loop 106 should receive the media 108 being provided by the user.

The user can remove media 108 from a loop 106 by dragging the media 108 out of the loop 106, or identifying to the media engine 104 the media 108 to remove. Any manner of identifying the media 108 the user desires to remove from a loop 106 is within the scope of various embodiments. For instance, the user can highlight the item of the media 108 within the loop 106 and select a remove option from a drop down menu.

The media engine 104 updates the loop 106 to reflect the removal of the media 108. The media engine 104 may remove the identifiers associated with the removed media 108, or the media engine 104 can alter the metadata associated with the removed media 108. Conversely, as discussed herein, the user can add the media 108 back into a loop 106 by dragging and dropping the media 108 into the loop 106 to which the user wishes to add the media 108 or by identifying the media 108 to the media engine 104 that the user wishes to add to the loop 106.

In one embodiment, the identifiers for the loop(s) 106 and/or the media 108 may be assigned by a server 112, such as an “application server.” The server 112 may be accessed directly by the client 102 or via the network 110. The server 112 can communicate the identifiers for the loop(s) 106 and/or the media 108 to the media engine 104, so the media engine 104 can store and locate the identifiers. In exemplary embodiments, the server 112 or the media engine 104 may also transmit the identifiers for the loop(s) 106 to the content input device 118 to update a menu from which the user is able to specify the loop(s) 106.

When the user removes, adds, or modifies an item of the media 108 from the loop 106, the server 112 can store and/or track the removals, additions, and/or modifications as updates to the loop 106. The user can also update the loop 106 by making changes to items of the media 108 in the loop 106. For example, if the user resizes an image of the media 108, the media engine 104 and/or the server 112 can include the resized image as an update to the media 108 in the loop 106. In one embodiment, the server 112 may assign the identifier to the resized image in the media 108 and include the resized image as an update to the media 108 in the loop(s) 106. Any type of modifications to the media 108 and/or the loop 106 is within the scope of various embodiments.

In one embodiment, the user of the client 102 shares one or more of the loops 106 with one or more users of one or more other clients 114. The other clients 114 may also include one or more media engines for playing the loop(s) 106, creating the loop(s) 106, modifying the loop(s) 106, and so on. The server 112 assigns the same identifier to the loop(s) 106 shared by the client 102 and the client(s) 114.

When a user from the client 102 makes updates to the loop(s) 106 having an identifier shared by the loop(s) 106 at the client(s) 114, the client(s) 114 receive the same updates to the loop(s) 106. As discussed herein, the updates may include any modifications to the loop(s) 106 and/or the media 108 comprising the loop(s) 106.

The server 112 can provide the updates to the loop(s) 106 on the client(s) 114 automatically, at any time after the user at the client 102 makes updates to the loop(s) 106. In one embodiment, the server 112 makes requests to the media engine 104 at various times for changes made to the loop(s) 106 at the client 102. In one embodiment, the server 112 waits for notifications from the client(s) 114 of changes made to the loop(s) 106, then provides the updates to the client(s) 114 that have loops 106 with the same identifiers. Similarly, changes made by the client(s) 114 may be automatically provided to the client 102.

In one embodiment, the media engine 104, the content input device 118, or any other component associated with the client 102 assigns a temporary identifier to the media 108 dragged into or otherwise added to the loop 106. The client 102 then forwards the media 108 with the temporary identifier to the server 112. The server assigns a permanent identifier to the media 108 and forwards the media 108 with the permanent identifier back to the client 102 and/or to the other client(s) 114 as an update. The temporary identifier associated with the media 108 and/or the permanent identifier associated with the media 108 may further be associated with the identifier assigned to the loop(s) 106. Any type of method for assigning identifiers to the media 108 and/or the loop 106 may be employed by any device according to various embodiments.

The one or more users at the client(s) 114 may also make updates to the loop(s) 106 that have the same identifiers as the loop(s) 106 at the client 102. In one embodiment, the user that originates a shared loop 106 can create permissions for the loop 106. For instance, the originating user may require a password before other users can submit updates to the shared loop(s) 106.

Since the server 112 may automatically distribute the updates to the client(s) 102 and 114 with loop(s) 106 that have shared identifiers, only a single act is required by the user to share the updates to the loop(s) 106 with the users at the client(s) 102 and 114.

In one embodiment, users may subscribe to loop(s) 106. For example, the user at the client 102 may post movie oriented loop(s) 106 to the Internet and other users may subscribe to those movie oriented loop(s) 106 via a registration process. For the users that subscribe to the movie oriented loop(s) 106, updates are received when the originating user makes modifications to the movie oriented loop(s) 106. As discussed herein, a user, vendor, retailer, advertiser, etc. may make loop(s) 106 available for subscription.

Once the loop(s) 106 have been set up by various users and assigned unique identifiers, the server 112 and/or the media engine 104 keeps track of the loop(s) 106 and any changes thereto. Accordingly, since the server 112 automatically distributes, or otherwise distributes, the updates to the client(s) 114 with the loop(s) 106 with shared identifiers based on the user at the client 102 modifying the loop(s) 106 by adding, removing, or changing one or more items of the media 108 within the loop(s) 106, only a single act is required by the user to share the updates to the loop(s) 106 with the users at the client(s) 114.

In one embodiment, master copies of the loop(s) 106 may be stored on the server 112. Accordingly, the user at the client 102 can modify the loop(s) 106 by accessing the server 112. The user may access the server 112 via the network 110 or in any other manner. Alternatively, the server 112 may include an index for locating the various loop(s). In another embodiment, the loop(s) 106 may be stored at the server 112, while the client 102 and/or the client(s) 114 utilize an index to retrieve particular loop(s) 106 when desired. Any storage medium may be utilized for storing the loop(s) 106, copies of the loop(s) 106, metadata, and/or indexes according to various embodiments.

In another embodiment, the server 112 may store the master copies of all the loop(s) 106 for all users along with the identifiers for the loop(s) 106 and the media 108. Accordingly, the server 112 can search for loop(s) 106 based on the identifiers, receive updates to the loop(s) 106 when users associated with the loop(s) 106 makes changes to the loop(s) 106, and automatically distribute updates for the loop(s) 106 to all user associated with the loop(s) 106. In still another embodiment, the loop(s) 106 may be stored on the server 112 in order to minimize storage on the client 102 and/or the client(s) 114, as discussed herein.

In still another embodiment, the server 112 may store versions of the loop(s) 106. Accordingly, the server 112 may maintain various copies of the same loop(s) 106, as different versions. According to another embodiment, the client 102 and/or 114 may store different versions of loop(s) 106 generated by the client 102 or of shared loop(s) 106. The server 112 and/or the client 102 may maintain an index for organizing and tracking the various versions of the loop(s) 106 according to some embodiments.

In one embodiment, a content provider 116 is coupled to the server 112 in order to provide content for the loop(s) 106. The content provider 116 may directly coupled to the server 114 or the content provider 116 may be coupled to the server 112 via the network 110. In one embodiment, the content provider 116 is coupled to the client 102 and/or the client(s) 114 in order to directly provide the content to the loop(s) stored on the client 102 and/or the client(s) 114.

In exemplary embodiments, the content provider 116 provides advertising content to the loop(s) 106. Alternately, the content provider 116 may provide any type of content. In one embodiment, each of the loops 106 must include at least one item of the content from the content provider 116. More than one content provider 116 may be provided according to various embodiments. Accordingly, the loop(s) 106 may display advertisements or other content along with the other media 108 displayed by the loop(s) 106.

In one embodiment, the content provider 116 can specify how often the content appears within the loop(s) 106. For example, the content provider 116 may specify that the content should appear no less than between every 10th item of media 108 within the loop(s) 106. If the content provider 116 modifies the content, the server 112 or the content provider 116, itself, can distribute the modified content as updates to the loop(s) 106. Accordingly, the modified content replaces the existing content in the loop(s) 106.

In one embodiment, digital content may be electronically mailed to a central authority associated with the loop(s) 106. The central authority may then authenticate the user and distribute the digital content to appropriate loop(s) 106 and/or create new loop(s) 106 based on the digital content. The authentication may be based on username, password, and/or any other information related to the user submitting the digital content.

Although the media engine 104 at the client 102 is described as creating the loop(s) 106 from the media 108, one or more media engines 104 at the client(s) 114 can also provide the media 108 and create the loop(s) 106, modify the loop(s) 106, and so on. In other words the client 102 and the client(s) 114 are capable of performing similar or identical functions with respect to the loop(s) 106.

The content input device 118 comprises a mobile computing device that is able to capture media 108, and generate and transmit an instruction comprising the media over a communication network 110. The content input device 118 may comprise a digital camera, a digital movie camera, and/or a microphone/voice recorder. A user may transmit the instruction from a remote location, the instruction comprising a copy of the media 108 to be added to the loop 106 and a unique identifier, using the content input device 118. Unlike the client 102, the content input device 118 may not be configured to display or otherwise edit the loop 106. In some embodiments, the instruction comprises the location the media 108 was generated (e.g., location of photograph), the time the media 108 was generated, and the orientation of the media (e.g., landscape). The instruction may also comprise the type of content input device 118 that generated the media 108/

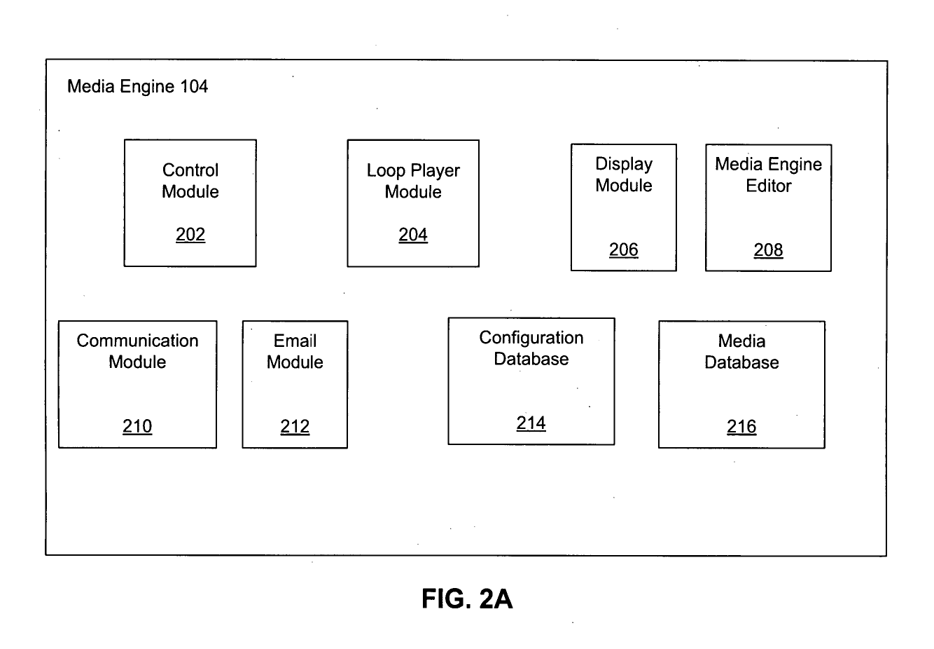

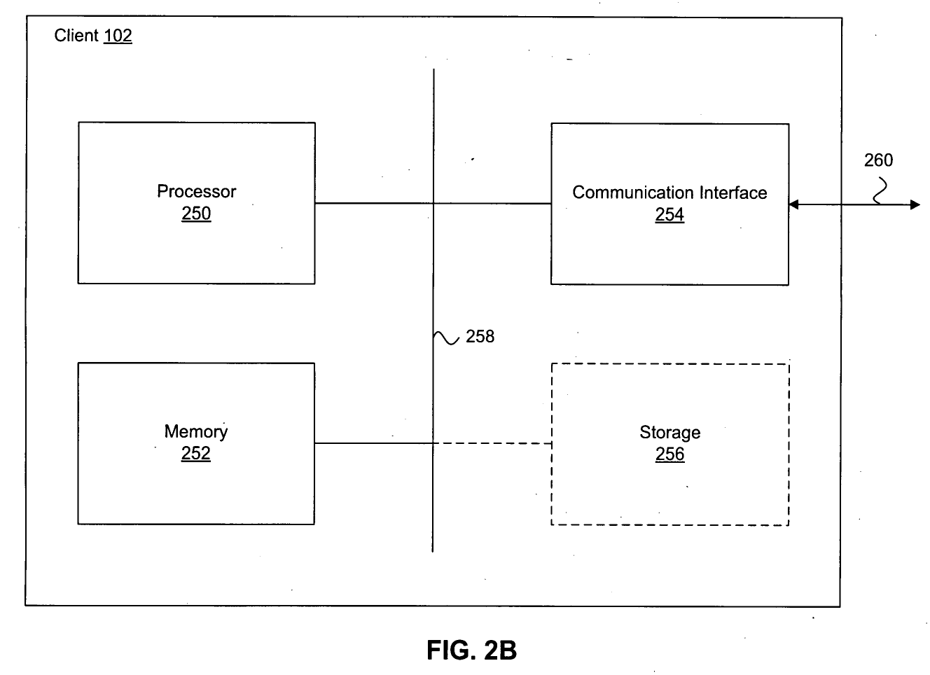

Referring to FIG. 2A, a diagram for an exemplary media engine 104 is shown. A loop control module 202 manipulates the media 108 (FIG. 1) and constructs the loop(s) 106 (FIG. 1) from the media 108. The loop(s) control module 202 provides a default speed at which the loop(s) 106 plays. In a further embodiment, a user can specify the speed for playing the loop(s) 106 or adjust the speed from the default speed. The loop control module 202 may coordinate with the content provider 116 (FIG. 1) to insert specific content into the loop(s) 106 at specific times or in specific time intervals.

A player module 204 plays the loop(s) 106. The player module 204 may be utilized to control a direction and a speed at which the loop(s) 106 plays. The player module 204 may have a default direction, which may be changed by the user.

A display module 206 provides a graphical user interface (GUI) for allowing the user to interact with logic of the media engine 104. For instance, the display module 206 allows the user to interact with the media engine 104 to read and write the media 108. In other words, the display module 206 allows the user to-create, modify, and/or remove the media 108 and/or the loop(s) 106 by choosing from on-screen selections and/or manipulating on-screen items. The display module 206 may also execute the media 108 from within a window, display the media 108 alone or as part of the loop(s) 106, and/or perform any functions related to display and user interaction with the display.

As discussed herein, the-display module 206 allows the user to. drag and drop the media 108 into the loop(s) 106 and remove the media 108 from the loop(s) 106. The user can drag and drop the media 108, click a button, or initiate a voice command to send the media 108 changes to the media engine 104.

Any type of display module 206 is within the scope of various embodiments. For instance, the display module 206 need not be a typical visual display, but may be a text-based display module for allowing the user to interact with the logic of the media engine 104 based on text command lines.

A media engine editor 208 allows the user to make adjustments to the media 108. For example, the user can use the media engine editor 208 to resize the media 108, rotate the media 108, configure the media 108, format the media 108, and so forth. For instance, the user may resize an image or change the font type in text associated with the media 108. Any type of editing may be accomplished using the media engine editor 208.

In one example, the media engine editor 208 can make edits based on metadata or instructions received from the content input device 118. In one example, the media engine editor 208 may auto-rotate or otherwise correct the orientation of the media 108. In some embodiments, the media engine editor 208 can make color corrections on the media 108. In one example, the media engine editor 208 makes color corrections to the media 108 based on an analysis of the media 108. In another example, the media engine editor 208 makes color corrections to the media 108 based on the type of content input device 118 used to generate the media 108. Further, the media engine editor 208 may make color corrections to the media 108 based on a type of screen used to display the media 108 to the user or any device that may output the loop 106 and/or media 108 (e.g., a printer).

In exemplary embodiments, the media engine editor 208 can auto-order the media 108 received from the content input device 118. In one example, the media engine editor 208 ensures that media 118 is placed within a loop 106 in the order that was received from the content input device 118 or in an order based on the time the media 118 was generated (e.g., time a photograph was taken.) The time the media 118 was taken may be contained within the instructions received from the content input device 118 previously discussed.

A communication module 210 allows the media engine 104 to utilize the components of the client 102 for communicating with the server 112 to send and receive updates for the loop(s) 106 running in the media engine 104, and to transfer any other data between the media engine 104 and the server 112. The communication module 210 is further configured to communicate with the content input device 118 to receive media 108 to be added to the loop(s) 106. In some embodiments, the communication module 210 may additionally transmit a listing of the loops and/or loop identifiers associated with the client 102 to the content input device 118.

An electronic mail interface 212 may be provided as a communications interface for electronic mails. Any type of electronic mail interface 212 may be provided. The electronic mail interface 212 may be utilized for sending the loop(s) 106, the media 108, metadata, or identifiers associated with the loop(s) 106 and/or the media 108 directly other users.

A configuration database 214 may be utilized to store the one or more identifiers associated with the media 108 and/or the loop(s) 106. As discussed herein, when the loop(s) 106 is created using the media 108 or updates to the loop(s) 106 are provided, an identifier is assigned to the loop(s) 106 or the media 108. In further embodiments, the media 108 in the loop(s) 106 is assigned an identifier that is unique within the loop(s) 106.

The configuration database 214 may store any type of data related to the loop(s) 106, such as information regarding a host computer system, type and quality of an attached network, communications performance, registration information for the client 102, version number for the loop(s) 106 and the media 108 comprising the loop(s) 106. Any type of configuration database 214 may be utilized in accordance with various embodiments. As discussed herein, in one embodiment, the identifier is stored on the server 112 and/or in the configuration database 214. In alternative embodiments, the configuration database 214 may comprise more than a database. In yet a further embodiment, the configuration database 214 may be located outside the media engine 104, but be coupled thereto. It should be noted that the configuration database 214 and the media database 216 may comprise a single database.

A media database 216 may be provided for storing the media 108. In one embodiment, the content from the content provider 116 is stored in the media database 216. Any process for storing the media 108 may be utilized in association with the media database 216. For example, a hash function may be utilized to index and retrieve the media 108 in the media database 216 or from one or more other storage mediums.

Although the media engine 104 is described as including various components, the media engine 104 may include more components or fewer components than those listed and still fall within the scope of embodiments of the invention. For example, the media engine 104 may also include a media cache/buffer for short term storage of the media 108, an input/output (I/O) component for receiving and sending data at the client 102, a contact database for storing information associated with contacts, a user activity component for tracking activity of the user with respect to the media 108 and/or the loop(s) 106, and so forth.

FIG. 2B is a block diagram of a client 102 in an exemplary implementation of the invention. The client 102 may have a similar configuration as the client(s) 114. The client 102 includes a processor 250, a memory 252, a communication interface 254, and storage 256 which are all coupled to a system bus 258. The processor 250 is configured to execute executable instructions.

The memory 252 is any memory configured to store data. Some examples of the memory 252 are storage devices, such as RAM or ROM.

The communication interface 254 is coupled to the network 110 via the link 260. The communication interface 254 is configured to exchange communications between the network 110 and the other elements in the client 102. In some embodiments, the communication interface 254 may comprise a Local Area Network interface and a Wide Area Network interface.

The storage 256 is any storage configured to retrieve and store data. Some examples of the storage 256 are hard drives, optical drives, and magnetic tape. The storage 256 can comprise a database or other data structure configured to hold and organize data. In some embodiments, the client 102 includes memory 252 in the form of RAM and storage 256 in the form of a hard drive.

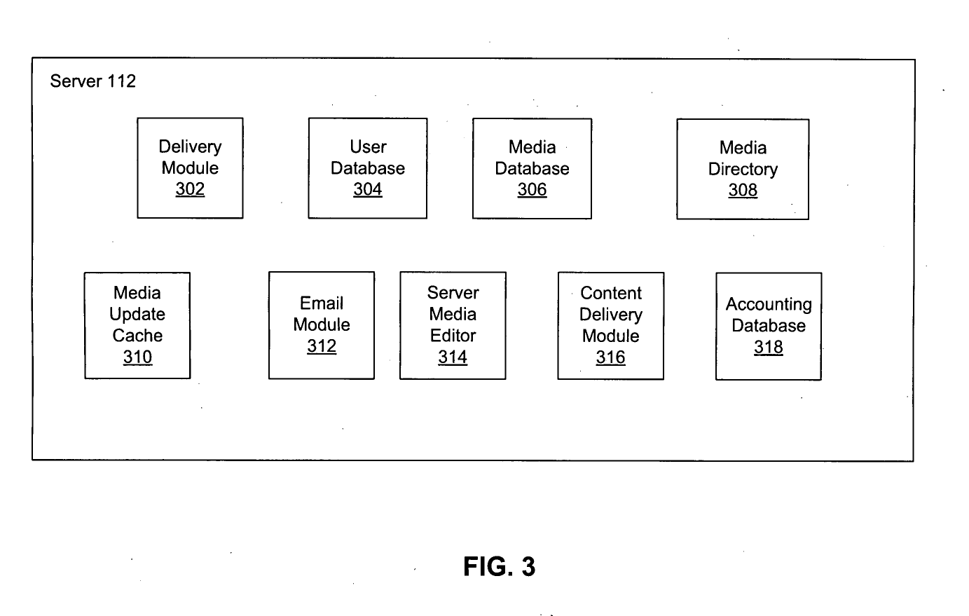

FIG. 3 illustrates exemplary components associated with the server 112 in accordance with one embodiment. The server 112 generates, tracks, and updates media 108 identifiers, loop 106 identifiers and user identifiers. The server 112 comprises a delivery module 302, a user database 304, a media database 306, a media directory 308, a media update cache 310, an electronic mail module 312, a server media editor 314, a content delivery module 316, and an accounting database 318.

A delivery module 302 may be provided for delivering the loop(s) 106 (FIG. 1), the media 108 (FIG. 1) that comprise the loop(s) 106, and the identifiers assigned to the loop(s) 106 and the media 108 to the clients 102 and 114.

In one embodiment, the media 108 is provided to the media engine 104 for creating the loop(s) 106. The media engine 104 then requests the server 112 create the loop(s) 106 with the media 108. Alternatively, as discussed herein, the media engine 104, itself, may create the loop(s) 106. The server 112 and/or the media engine 104 can assign an identifier to the loop(s) 106 and to each of the one or more items of media 108 comprising the loop(s) 106. If the server 112 creates the loop(s) 106 or maintains a master copy of the loop(s) 106, the server 112 can deliver the loop(s) 106 to the media engine 104 via the network 110, as discussed herein. However, any manner of delivering the loop(s) 106 to the media engine 104 is within the scope of various embodiments.

A user database 304 may be provided for storing user information, such as first and last names, electronic mail addresses, user identifiers, identifiers of content input devices 118, and so on. The user database 304 may also store information associated with the loop(s) 106 that the user created or received from other users. Based on the identifiers from the loop(s) 106, the user database 304 can provide the media 108 as updates to the appropriate loop(s) 106 in the loop players 104 running on the client 102 or the client(s) 114. Optionally, a user may be required to register certain information with the server 112 before the server 112 will provide the loop(s) 106 with the media 108 to the media engine 104 (FIG. 1) associated with the user. Alternatively, the user may be required to register in order to receive the identifier for the media 108 and/or the loop(s) 106.

A media database 306 may also be provided for storing the media 108 the loop(s) 106 and/or any metadata or configuration information associated with the loop(s) 106 and/or the media 108. As discussed herein, the media 108 and/or the loop(s) 106 may include, for example, multimedia, photographs, sounds, music, pictures, streaming media, animation, movies, and graphics. Any type of media 108 may comprise the loop(s) 106.

A media directory 308 may be provided for indexing the media 108 stored in the media database 306. For example, in one embodiment, the media directory 308 may allow the loop(s) 106 and/or media 108 to be retrieved that have the word “fishing” in their titles or descriptions. Any indexing and searching by the media directory 308 on any information or metadata associated with the loop(s) 106 or the media 108 is within the scope of various embodiments.

A media update cache 310 stores the media 108 that is utilized to update, or otherwise modify, the loop(s) 106. The media update cache 310 may further store media received from the content input device 118 to be added to the loop(s) 106.

An electronic mail module 312 sends electronic mail for the user at the client 102 to the one or more other users at the client(s) 114, providing the users at the client(s) 114 with information for retrieving or constructing the loop(s) 106 and/or the media engine 104.

A server media editor 314 may be provided for modifying the media 108. The user can modify the media 108 utilizing the server media editor 314 via the server 112 rather than, or in addition to, the media engine editor 208 (FIG. 2). For example, the server media editor 314 may be used to resize photos, rotate photos, remove red eye from photos, correct color balance, cleanse the media 108 of viruses, and so forth.

As discussed in FIG. 1, a content provider 116 may be coupled to the server 112. Alternatively, the function of the content provider 116 may be performed by a content delivery module 316 within the server 112. The content delivery module 316 provides advertising and/or any other type of content to be included as one or more items of the media 108 within the loop(s) 106.

In one embodiment, the advertising and/or content from the content delivery module 316 may be provided based on an analysis of the user of the loop(s) 106. For example, an advertisement for toothpaste may be provided to a user with family related loops 106. However, any manner of determining the advertising and/or the content to be provided by the content delivery module 316 to the loop(s) 106 may be employed, such as arbitrarily choosing the advertising and/or the content.

In one embodiment, the media 108 may comprise one or more advertising media inserted into the loop(s) 106. As discussed herein, the content provider 116 and/or the content delivery module 316 may dictate how frequently the advertising media, or other content, appears. For instance, the advertising media may appear twice in the loop(s) 106, once for every five items of the media 108 in the loop(s) 106, and so on.

A commercial loop(s) 106 may also be created utilizing the content delivery module 316. The commercial loop(s) 106 may include media with embedded music, streaming video, audio, and/or other multimedia effects. A user may choose to allow the commercial loop(s) 106 to play on a screen associated with the user's client 102.

The server 112 may also include an accounting module 318. The accounting module 318 can track the media 108 within the loop(s) 106, and track the frequency and type of interaction each of the users has with the loop(s) 106 on the media 108. Specifically, the accounting module 318 is useful for tracking the interaction between the user and the advertisement media included within the loop(s) 106. Accordingly, the accounting module 318 can track monies due to a provider of the advertising media based on user interaction with the advertising media.

Although the server 112 has been described as including various components, fewer or more components may comprise the server 112 in accordance with various embodiments. For instance, the server 112 may also include a search engine component, a communications interface.

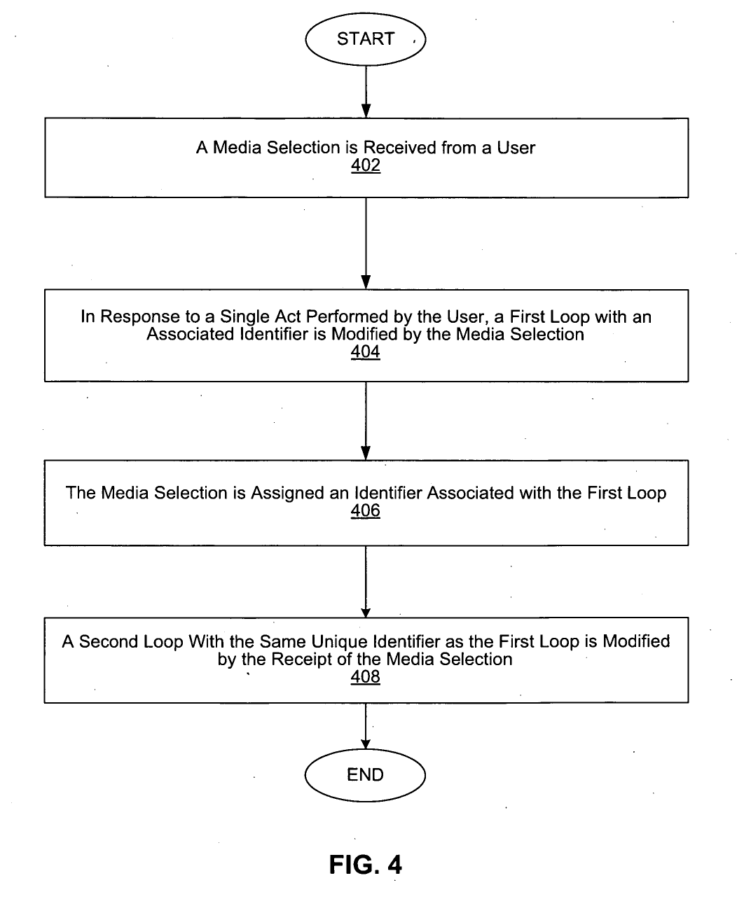

FIG. 4 illustrates an exemplary flow diagram for single act media sharing. At step 402, a media selection is received from a user. The media selection may include adding new media, removing media, or modifying existing media, such as the media 108 discussed in FIG. 1. The media selection may be received from the content input device 118. As discussed herein, the user may initiate the single act via a button, a keystroke, a voice command, a drag and drop operation, and so forth. Any single act by the user for providing the media selection is within the scope of various embodiments. The user may provide the media selection to a loop player, such as the media engine 104 discussed in FIG. 1, or a loop interface on a content input device 118.

In exemplary embodiments, a loop 108 graphical user interface (GUI) may be embedded within the software of the content input device 118. The GUI may allow the user of the content input device 118 to preview the media 108, select a loop 106 to place the media within, order the media 108 within the loop 106, create a new loop 106 to place the media 108 within, or set any properties for the media 108 or the loop 106 (e.g., security or sharing). In other embodiments, the GUI may be contained within a driver of the content input device 118. In one example, the content input device 118 software is installed on a digital device of the user to control the operation of the content input device 118 (e.g., a software driver). The content input device 118 software may contain the GUI previously discussed.

At step 404, in response to the single act performed by the user, a first loop having an identifier is modified by the media selection. The media 108 that was selected is added to, removed from, modified or updated within the loop(s) 106.

At step 406, the media selection is assigned the identifier assigned to the first loop. The identifier assigned to the media selection may also be unique within the first loop. By assigning the identifier to the media selection that is unique within the first loop, the media engine 104 and/or the server 112 can associate the media selection with the first loop and any other loops sharing the identifier. Steps 404 and 406 may be performed in reverse order or simultaneously in various embodiments.

At step 408, the media selection is forwarded to a server that modifies a second loop with the same identifier as the identifier assigned the first loop. In other words, the single act of the user sending the media selection to the media engine 104 shares the media selection with other users having second loops with identifiers shared with the first loop, once the other users download the updates from the server. As discussed herein, the client 102 may notify the server 112 of updates to the loop(s) 106, the server 112 may periodically check for updates, the other client(s) 114 may periodically request updates, and so forth. Any manner of obtaining and forwarding the updates is within the scope of various embodiments. For example, the client 102 may forward updates directly to the other client(s) 114 based on a notification from the server 112 that the other client(s) 114 have not received the updates.

In another embodiment, the server 112 may maintain an index of the loop(s) 106. When an update occurs, the server 112 may retrieve the update from the client 102 and forward the update to the other client(s) 114 or direct the client 102 to forward the update to the other client(s) 114. According to another embodiment, the client 102 and/or the client(s) 114 may include server oriented devices that can check for and forward the updates to the loop(s) 106 directly from the client 102 to the other client(s) 114 and vice versa.

In exemplary embodiments, the user at the client 102 provides the media selection, such as the media 108 discussed in FIG. 1, to the media engine 104. The media engine 104 creates two copies of the media selection and saves, and/or caches, the two copies of the media selection. Either or both copies of the media selection may be saved to a storage medium, such as the media database 216 discussed in FIG. 2. Optionally, only one copy of the media selection is saved and/or cached.

The media engine 104 displays the first media selection on a screen associated with the client 102 as part of the loop(s) 106 being played. The media engine 104 creates and sends a second copy of the media selection to a server, such as the server 112 discussed in FIG. 1. The server 112 stores the second copy of the media selection in the media directory 308 (FIG. 3) and/or in the media update cache 310. The server 112 sends the second copy of the media selection to other users associated with the client(s) 114 if the identifier associated with the media selection (i.e., the copies of the media selection) and/or the first loop matches the identifier associated with the second loop(s) 106 at the client(s) 114. As discussed herein, according to some embodiments, the server 112 may assign a permanent identifier to the media selection to replace the temporary identifier assigned to the media selection by the media engine 104 at the client 102.

As discussed herein, the server 112 can create and send the second copy of the media selection to the client(s) 114 automatically, or in response to requests from the client(s) 114 for the second copy of the media selection (i.e. the updates to the second loop(s) 106). Accordingly, the second loop(s) 106 is modified in response to a single action, or single act, by the user at the first client 102 interacting with the first loop(s) 106. In alternative embodiments, the second loop(s) may be updated in response to a media 108 selection by the user at a content input device 118.

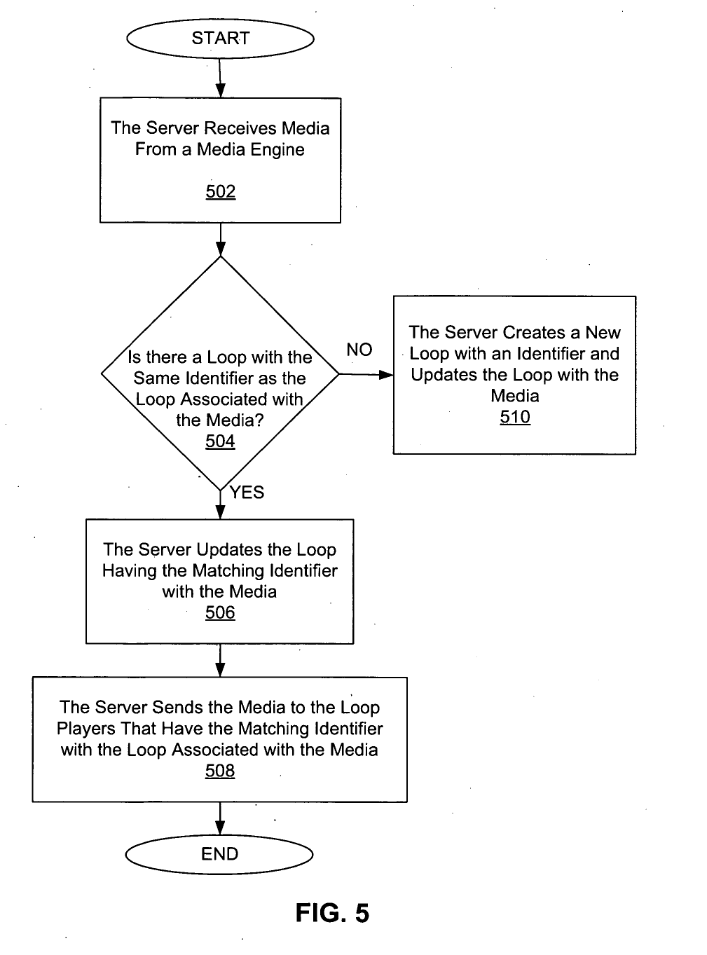

Referring to FIG. 5, another exemplary flow diagram for sharing media in response to the single act by the user is shown. At step 502, the server 112 receives one or more items of the media 108 and loop(s) 106 identifiers corresponding to the one or more items of the media 108 from the media engine 104.

At step 504, the server 112 determines whether there is an existing loop(s) 106 with an identifier that matches the identifier associated with the media 108. The determination may be performed by means of a hash function, checksum, or a like algorithm within the media directory 308.

At step 506, if there is an existing loop(s) 106 that matches the identifier associated with the media 108, the server 112 updates the loop(s) 106 having the matching identifier with the media 108 by adding the media 108.

At step 508, the server 112 sends the media 108 with the matching identifier for the loop(s) 106 to the client(s) 114 making the requests for the updates. As discussed herein, the loop(s) 106 associated with the client(s) 114 is then updated with the media 108 having the matching identifier. Further, the media 108 may be forwarded to the client(s) 114 as updates based on requests from the client(s) 114 for updates, periodic pushes from the server 112 of updates, and/or notification by the client 102 that updates have occurred.

If, at step 504, the server 112 determines that there is not a loop(s) 106, with an identifier that matches identifier of the loop(s) 106 with the media 108, the server 112, at step 510, creates a new loop(s) 106 and assigns the same identifier to the new loop 106 and updates the new loop(s) 106 with the media 108. As discussed herein, the server 112 may communicate the identifier to the configuration database 214 at the first client 102 for storage and/or reference. The server 112 then transmits the media 108 and the new loop(s) 106 to one or more clients 114 granted permission by the user associated with the media engine 104 to access the new loop(s) 106.

In one embodiment, the media engine 104 assigns the same identifier to the media 108 and the new loop(s) 106 and communicates the identifier assigned to the server 112. The media engine 104 stores the identifier in the media database 216 or in the configuration database 214. The media engine 102 may further transmit the identifier of the new loop(s) 106 to one or more content input devices 118.

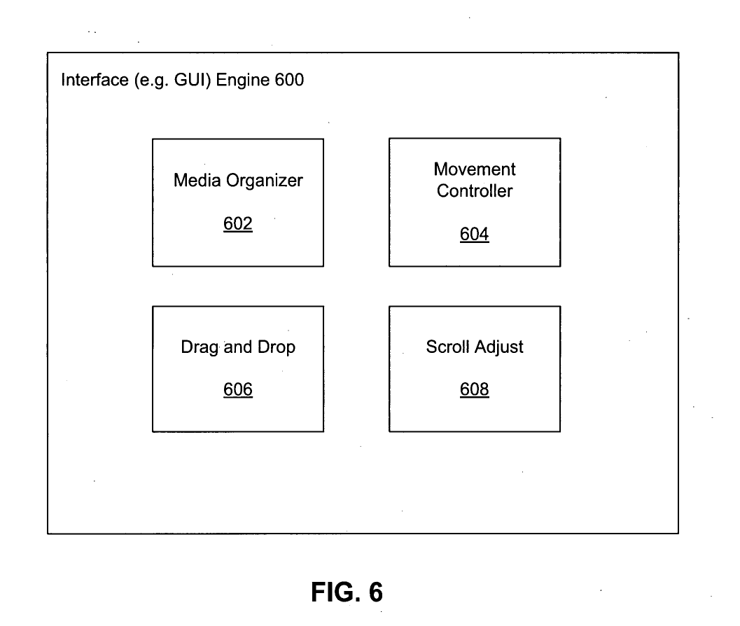

Turning now to FIG. 6, an exemplary graphical user interface (GUI) engine 600 for providing access to functions related to the media engine 104 (FIG. 1) is shown. In one embodiment, the GUI engine 600 is the display module 604 (FIG. 6). A media organizer 602 allows a user to organize the media 108 (FIG. 1) in the loop(s) 106 (FIG. 1). For example, the user can provide photos to the media organizer 602 via a drag and drop function, a keystroke, etc., and the media organizer 602 can automatically organize the photos according to default parameters or parameters specified by the user. The default parameter may be, for instance, to organize the photos according to dates associated with the photos. The user can specify any parameters, such as date, size, event, and so forth, for the media organizer 602 to use in arranging the media 108.

A movement controller 604 provides the user with a mechanism to regulate the pace of the loop(s) 106, as discussed herein, as it scrolls across a display device associated with the client 102. For example, the user may specify that the loop(s) 106 should scroll across the display device at a rate of one display device pixel per tenth of a second. The movement controller 804 also allows the user to specify the direction the loop(s) 106 should scroll across the display device of the client 102. For example, the user may specify that the loop(s) 106 should scroll left to right across the display device. Any manner of allowing the user to adjust the pace may be provided. For instance, the user may enter the scroll time into a box, move a slider between a slowest pace and fastest pace, select from scroll paces from a drop down menu, and so on.

A drag/drop manager 606 provides a mechanism for the user to modify the loop(s) 106 in a single drag and drop action. Thus, the user can drag one or more items of the media 108 into the loop(s) 106. The drag/drop manager 606 communicates the user action and information to other components/modules associated with the media engine 104 for automatically updating the loop(s) 106 to include the dropped media 108. As discussed herein, when the user performs this single act of dragging and dropping the media 108 into the loop(s) 106, one or more other loop(s) 106 that share the identifier are also updated with the dropped media 108. As discussed herein, the other loop(s) 106 may reside in other media engines 104 (FIG. 1) at the client(s) 114. Conversely, the user can drag one or more items of the media 108 away from the loop(s) 106, in order to remove the items. The loop(s) 106 that share the same identifier are also updated to no longer include the media 108 dragged away from the loop(s).

A scroll adjust 608 option may also be provided via the GUI engine 600. The scroll adjust 608 allows the user to manipulate the loop(s) 106 as they scroll across a display device. For instance, as the loop(s) 106 scrolls across the display device, the user can grab the loop(s) 106 with a mouse, keystroke, etc., and move the loop(s) 106. The user can stop the scrolling, slow down the scrolling, speed up the scrolling, and so forth by clicking on, moving, etc. the loop(s) 106, itself. The user can choose which of the loop(s) 106 and/or how many of the loop(s) 106 the user wants to scroll on the user's display device at one time.

Although an exemplary graphical user GUI engine 600 has been described, any type of graphical user interface engine with any type of functionality is within the scope of various embodiments. For example, the GUI engine 600 may include mechanisms for allowing functionality such as creating another loop when the user selects the one or more items of the media 108 comprising the loop(s) 108, displaying a larger image when the user selects the one or more items of the media 108 in the loop(s) 108, dragging and dropping the entire loop(s) 108 from one media engine 104 to another media engine 104, creating a new empty loop 108 from when the user selects an item of the media 108 in the loop(s) 108, sending an electronic mail message to other users that contains a copy of the entire loop(s) 108 or information related to specific loops 108, providing the ability to search for various loops 108 associated with the client 102, client(s) 114, and/or stored in a publicly accessible media directory 608, and so forth.

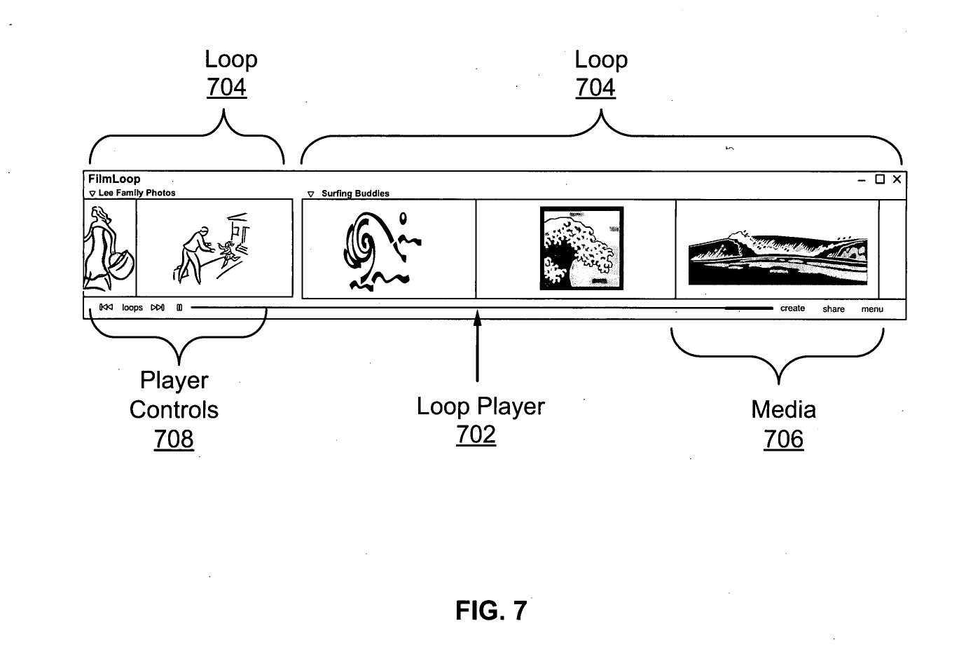

Referring now to FIG. 7, a screen shot of an exemplary loop 704, such as the loop(s) 106 discussed in FIG. 1, in accordance with one embodiment is shown. A loop player 702, such as a graphical representation of the media engine 104 discussed in FIG. 1, includes several loops 704. Each loop 704 includes several items of media 706, such as the one or more items of the media 108 discussed in FIG. 1. The loop player 702 plays the loop 704 by scrolling the various media 706 across a display device. The display device in FIG. 7 is a desktop display.

In FIG. 7, the loop player 702 is displaying two loops 704, one entitled “Lee Family Photos” and the other entitled “Surfing Buddies.” As shown, one item of the media 706 in the “Surfing Buddies” loop 704 is a picture of a first wave. As discussed herein, various types of media 706 may be included in the loop(s) 704, such as the photograph of the first wave, advertising content from a content provider, such as the content provider 116 discussed in FIG. 1, and so on. Although FIG. 7 shows two loops 704 adjacent to one another being played by the same loop player 702, a single loop 704 may scroll across a display device associated with a user according to various embodiments. In one embodiment, the user may scroll more than one loop 704 across the display device at different locations on the display device, rather than adjacent loops 704 played in one loop player 702, as discussed herein. Further, more than one loop 704, including adjacent loops 704 played by one loop player 702, may scroll across the display device of the user.

The loop player 702 may scroll the media 706 for the loop 704 across the display device at any speed and/or in any direction. The speed and/or direction may be a default speed, a default direction, and/or a direction and/or speed specified by the user. In one embodiment, the content provider 116 specifies the speed in order to ensure that the content provided appears at specified increments of time. In a further embodiment, the server 112 may also specify the speed and/or the direction.

The user may utilize player controls 708 to adjust the speed, the media 706 to display, and so on. For instance, the user can skip to a previous or next item of the media 706 by utilizing the player controls 708. The user can also pause the scrolling loop(s) 704. Furthermore, the user can stop the loop 704, reduce or expand the size of the loop 704, or minimize the loop 704. In one embodiment, the user may access a master set of controls that control more than one loop 704. In another embodiment, when the user adjusts the player controls 708 associated with the loops 704, other users' loop(s) 704 with the same unique identifier are automatically adjusted as well.

The media 706 in the loop 704, can be dragged away, or otherwise removed, from the loop 704 by a user, as discussed herein. When the user removes one or more of the items of the media, the loop player 702 updates the loop 704 to no longer include the one or more items of the media 108 that the user removed. The loop player 702 may also forward the update to a server, such as the server 112 described in FIG. 1. The server 112 may subsequently update the other users' loop(s) 106 that share the same identifier, with the removal of the one or more items of the media, in response to the single act by the user of removing the one or more items of the media from the user's loop 704. However, any manner of updating the loop(s) 106 is within the scope of various embodiments.

In order to drag the loop 704 and/or the loop player 702 to other areas of the display device, the user can grab the loop player 702 and move it to the desired area using a mouse, a keyboard, or any other coupled control device. The user can incorporate the loop 704 into a second loop, such as the loop(s) 106 discussed herein, by dragging and dropping the loop 704 into the second loop(s).

The user can drag the media 706 from the loop 704 to a second loop to modify the second loop with the media 706 that was dragged into the second loop. In one embodiment, the user may select from a drop down menu to copy and/or move the media 706 to another loop.

In one embodiment, the user may select a single frame from of the media 706, such as the photo of the first wave, in order to “open” the single frame or load a new loop associated with the single frame. Opening the single frame of the media 706 may enlarge the content that comprises the single frame, display an alternate version of the media 706 that comprises the single frame, make the content available for editing, stop the single frame content from moving (in the event of moving displays), direct the user to a URL address, and so on.

Opening the single frame of the media 108 may also present a new loop, or “sub loop”, associated with the single frame of the media 706. For instance, if a user associated with the loop 704 selects the frame with the photo of the first wave in the media 706 in the “Surfing Buddies” loop 704, a new loop comprising more surfing buddies photos and/or content may be revealed. Opening a single frame of the media 706 in a loop 704 having an advertisement may reveal a new loop with content provided solely by a content provider, such as the content provider 116 discussed in FIG. 1. Any type of new loop may be provided as a consequence of opening the single frame of the media 706.

In one embodiment, when the user selects a single frame of the media 706, the loop player 702 makes a request to a client (e.g., such as the client 102 and/or the client(s) 114), to launch a particular application running on the client 102 and/or the client(s) 114. For example, when a particular frame of the media 706 in the loop 704 is selected, the loop player 702 instructs a web browser installed on the client 102 to display a particular web page. The web page may be associated with subject matter for the single frame of the media 706.

In one embodiment, opening a single frame of the media 706 may provide an additional option of sending the single frame of the media 706 to one or more other users. For example, although two users may not share the loop(s) 704 with the same unique identifier, the two users may maintain the loop(s) 704 with similar subject matter. Accordingly, the users may send one or more of the single frames of the media 706 to one another in order to update content, inform one another of advertising, etc.

One or more of the frames of the media 706 can be shared between any users for any reason. In one embodiment, the content provider 116 (FIG. 1) pushes time sensitive information to users of the loop(s) 106 as one or more frames of the media 706. Any type of information may be provided to users of the loop(s) 704, such as news, financial data, sales information, new product offerings, single frames of the media 706 from other loop(s) 704 users, and so on. In one embodiment, the users of the loop(s) 704 can block single frames of the media 706 from being presented.

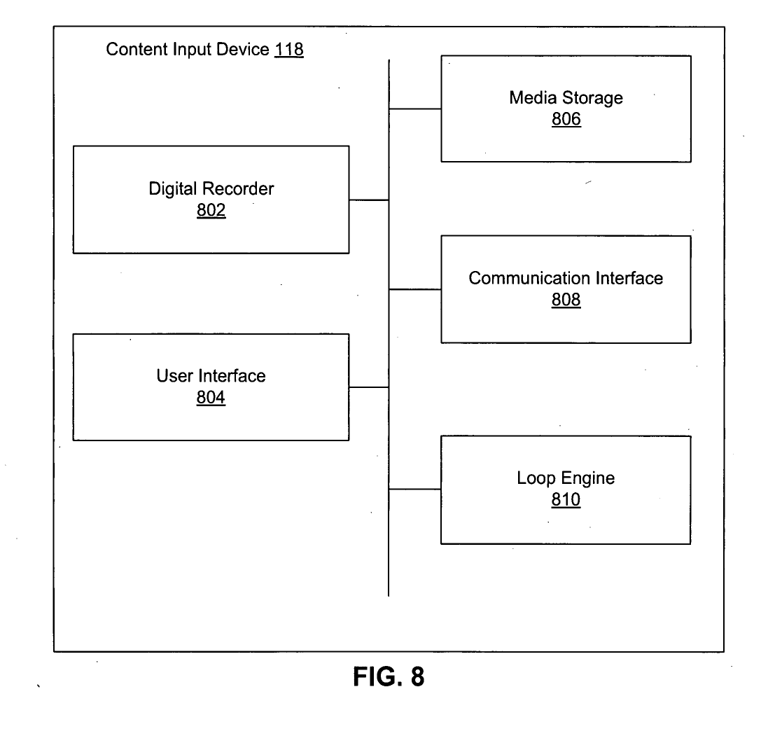

Referring now to FIG. 8, a diagram of a content input device 118 is depicted. Content input device(s) 118 provide a convenient means for making content available to the media engine 104 and/or the server 112 from a remote location. The content input device may require less battery or processing power than a media engine. The content input device may be configured to support a portion of the functionalities of the media engine. A content input device 118 need not be able to display a loop 106 and therefore is not necessarily configured to receive media 108 from the media engine 104. Thus, an intermittent connection is required between the content input device 118 and the media engine 104 to transmit content to the media engine 104 or the server 112. A connection may additionally be required to receive a listing comprising one or more loop identifiers associated with the user of the content input device 118.

As described more fully below, content is provided by a content input device 118 to the server 112 and/or the media engine 104 through mechanisms other than interaction with a loop 106 (e.g., drag and drop). In this way a user in a location that is remote from the client 102 can still provide content to a loop 106. Thus, other users that share the loop 106 will have access to the content. As an example, a new parent can add baby photos and video clips to a loop 106 shared by family members while still at the hospital.

One type of content input device 118 is a personal computing device comprising a digital recorder 802. The personal computing device may include a mobile telephone such as a cellular telephone, a personal digital assistant (PDA), a laptop, or other mobile device that is capable of wirelessly communicating over a network 110. The digital recorder 802 may comprise a camera and/or a voice recorder and is configured to capture images and/or sound. For example, the digital recorder 802 captures and stores digital images, video clips, and sound files, any of which can be provided to the server 112 and/or media engine 104. Some content input devices 118 can be used to input other forms of media including documents, PowerPoint presentations, slide shows, e-mails, text messages, and the like.

The content input device 118 comprises a user interface 804. The user interface 804 is configured to display captured media, menus, and the like to the user and receive input from the user in response to the display. The input may comprise a voice command, a menu selection, or key sequence. The user may use a keypad, a joystick, or other input device.

The media storage 806 of the content input device 118 is configured to store at least one media 108 captured by the digital recorder 802. The media storage 806 may comprise random access memory, read-only memory, FLASH memory, or the like. The media storage 806 may comprise a directory of the media 108 stored by the user on the content input device 118.

Using the communication interface 808, the content input device 118 sends an instruction comprising media 108 and/or a unique identifier to an address that specifies the media engine 104 or the server 112, such as a Uniform Resource Locator (URL). The communication interface 808 may wirelessly communicate over a cellular network, a WiFi connection to a LAN, a WAN or other network 110.

The loop engine 810 is configured to associate the media with a unique identifier such as an identifier of a content input device 118, user or loop 106 and generate the instructions sent over the network 110 to the media engine 104 or the server 112. Thus, when the media 108 is received by the server 112 or media engine 104, the media 108 can be associated with a user's account or with one or more specified loops 106. As noted above, media 108 received by the media engine 104 or server 112 can optionally be assigned an identifier and stored on the server 112 or the client 102. In certain embodiments, the loop engine 810 further generates a loop interface to allow the user to select a media 108 to be added to the loop(s) 106. In other embodiments, the loop engine 810 may select loops 106 to receive the media 108 based on metadata or instructions associated with the media 108. In one example, the content input device 118 transmits media 108 as well as instructions or metadata indicating the time the media 108 was generated. The loop engine 810 may place selected media 108 generated at certain times of the day or with certain settings (e.g., aperture settings or with flash) within selected loops 106.

In some embodiments, the loop engine 810 is configured to process loop identifiers received from the server 112 or the client 102 that are associated with a user of the content input device 118. The loop engine 810 generates a loop menu according to the loop identifiers.

Still another type of content input device 118 is a server intended to provide advertising content to the media engine 104 or server 112. As above, the content input server need not be configured to display a loop 106, only to provide content to the media engine 104 on an intermittent basis. It will be appreciated, therefore, that content input devices 118 are not limited to portable consumer electronics or communication over a wireless network.

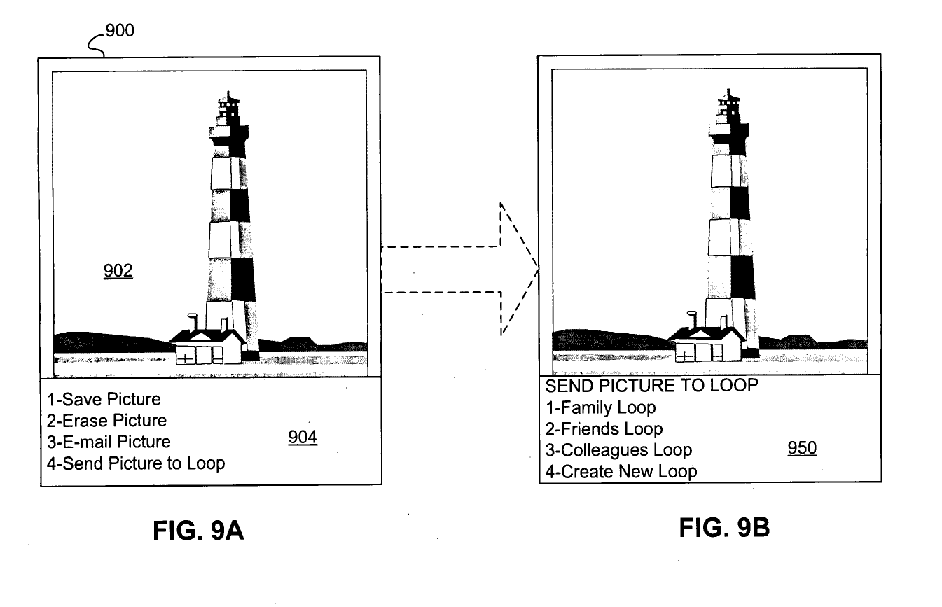

In FIG. 9A, a sample loop interface 900 is depicted. The loop interface 900 shown is intended to illustrate various embodiments of the invention and is not intended to limit the scope thereof. The loop interface 900 comprises a displayed media 902 and a menu 904. Using an input device such as a button, the user may select the option, “4-Send Picture to Loop.” After selecting this option, the media 108 may be sent to the media engine 104 to be added to a loop 106 set as a default by the user.

In a further embodiment, the loop interface 900 may optionally display a loop menu 950, depicted in FIG. 9B, when the loop option is selected by the user. The loop menu 950 comprises a listing of loop(s) 106 or loop categories associated with the media engine 104 that is associated with the user. The loop menu 950 allows a user to specify one or more loop(s) 106 to which the media 108 is added.

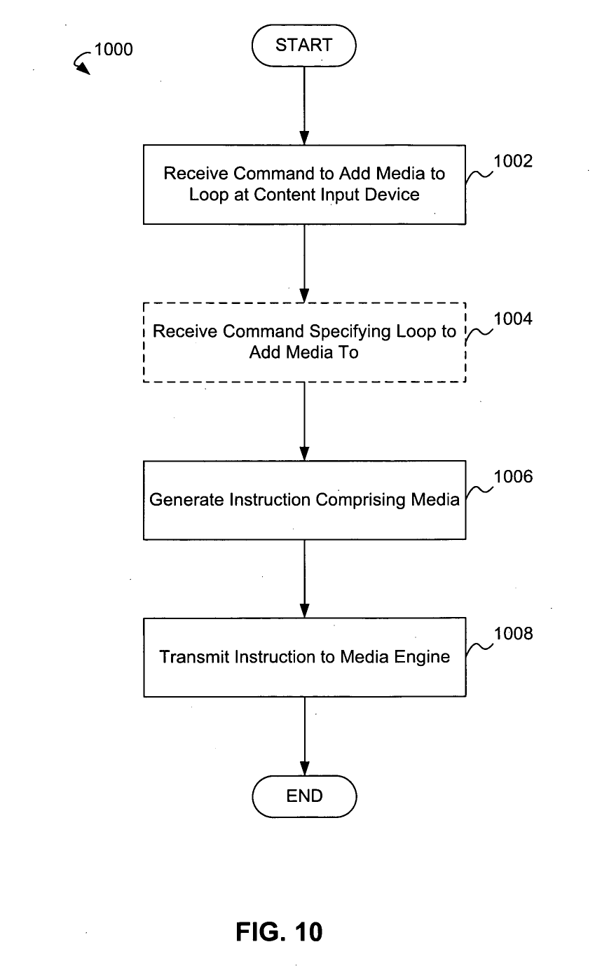

FIG. 10 depicts a flowchart 1000 of steps performed by the loop engine 810 to indicate that media 108 should be added to the loop(s) 106. The loop engine 810 allows users to distribute media 108 by performing only a single act from a content input device 118.

In step 1002, the loop engine 810 receives a command from a user to add media 108 to loop(s) 106 at the content input device 118. The command may comprise a selection from a menu such as the loop interface 900, a voice command, or the like. In optional step 1004, the loop engine 810 receives a further command specifying loop(s) 106 to which the media 108 is to be added. The command may be received using, for example, the loop menu 950.

In step 1006, the loop engine 810 generates an instruction comprising a copy of the media 108 and a unique identifier indicating the content input device 118, user, and/or loop(s) 106. In some embodiments, the unique identifier may comprise the permanent identifier assigned to the loop(s) by the server 112, or a temporary identifier assigned by the media engine 104. The temporary identifier may indicate that the loop 106 specified by the user is new. The temporary identifier may indicate one or more loops 106 within a category. In some embodiments, the unique identifier may comprise a user identifier or a content input device identifier indicating the user or device associated with the media engine 104. In step 1008, the loop engine 810 commands the communications interface 808 to transmit the instruction to the media engine 104 or the server 112.

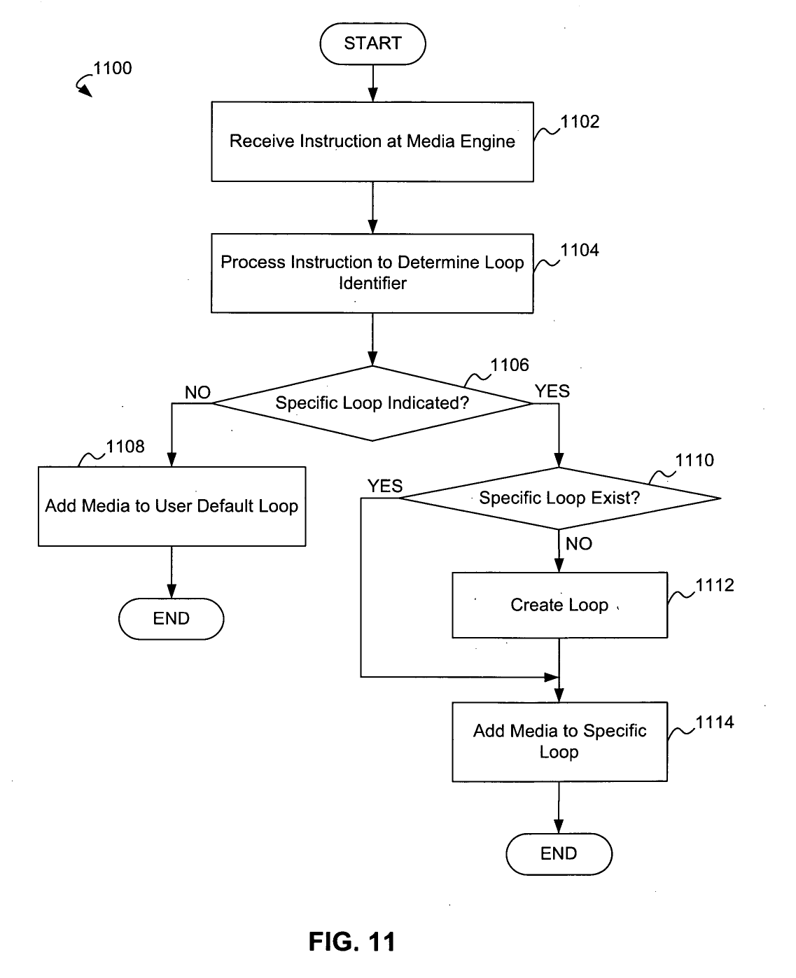

In FIG. 11, depicts a flowchart 1100 of the steps performed by the media engine 104 when the instruction is received from the content input device 118. These steps allow a user to add media 108 to a loop 106 from a remote device, such as a content input device 118, comprising a loop engine 810.

In step 1102, the media engine 104 receives the instruction from the content input device 118 or forwarded from the server 112. In step 1104, the media engine 104 processes the instruction to determine the loop identifiers of one or more loops 106 to which the media 108 is to be added. The determination is based on the unique identifier within the instruction. As discussed above, the unique identifier may comprise a loop identifier, a user identifier, or a content input device 118 identifier.

In step 1106, the media engine 104 determines whether a specific loop 106 is indicated. If not, in step 1108, the media can be added to a default loop 106. For example, a user can set a default preference that all received media 108 should be added to a particular loop 106. Alternately, media 108 can be stored by default in a file or folder associated with the user but not added to any loops 106. Other media handling preferences can be defined that are specific to the device type of the content input device, to the type of media, to the day of the week, time, or date, to an e-mail address of the sender, and so forth. Where media is sent as an e-mail attachment, for instance, handling instructions can be specified to the media engine 104 or server 112 in the body of the e-mail.

If a specific loop 106 is indicated, in step 1110, the media engine 104 determines whether the specific loop 106 exists. If the loop 106 does not exist, the media engine 104 creates a new loop 106 as described above. In step 1114, the media engine 104 adds the media 108 to the specific loop 106 or to the new loop 106 according to the instruction.

The above-described functions can be comprised of executable instructions that are stored on storage media. The executable instructions can be retrieved and executed by the processor 250. Some examples of executable instructions are software, program code, and firmware. Some examples of storage media are memory devices, tape, disks, integrated circuits, and servers. The executable instructions are operational when executed by the processor to direct the processor to operate in accord with the invention. Those skilled in the art are familiar with executable instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A system for distributing a media, the system comprising:
a communication interface configured to receive an instruction from a content input device, the instruction comprising the media; and
a processor configured to process the instruction to determine a loop identifier, determine a first loop to add the media to using the loop identifier, and add the media to the first loop.

2. The system of claim 1 wherein the instruction indicates a user identifier.

3. The system of claim 2 wherein the user identifier is associated with a default loop.

4. The system of claim 1 wherein the communication interface is configured to transmit a list comprising the loop identifier to the content input device.

5. The system of claim 1 wherein the processor is configured to create the first loop.

6. A method for distributing a media, the method comprising:
receiving an instruction from a content input device, the instruction comprising the media;
processing the instruction to determine a loop identifier;
determining a first loop to add the media to using the loop identifier; and
adding the media to the first loop.

7. The method of claim 6 wherein the instruction indicates a user identifier.

8. The method of claim 7 further comprising associating the user identifier with a default loop.

9. The method of claim 6 further comprising transmitting a list comprising the loop identifier to the content input device.

10. The method of claim 6 further comprising creating the first loop.

11. A software product for distributing a media, the software product comprising:
software operational when executed by a processor to direct the processor to receive an instruction from a content input device, the instruction comprising the media, process the instruction to determine a loop identifier, determine a first loop to add the media to using the loop identifier, and add the media to the first loop; and
a storage medium configured to store the software.

12. The software product of claim 11 wherein the instruction indicates a user identifier.

13. The software product of claim 12 the software operational when executed by the processor to direct the processor to associate the user identifier with a default loop.

14. The software product of claim 11 the software operational when executed by a processor to direct the processor to transmit a list comprising the loop identifier to the content input device.

15. The software product of claim 11 the software operational when executed by a processor to direct the processor to create the first loop.

16. A system for providing a media, the system comprising:
a digital recorder configured to capture the media;
a user interface configured to receive a selection of the media, the selection indicating that the media is to be added to a first loop;
a processor configured to generate an instruction comprising a copy of the media indicating the first loop; and
a communication interface configured to transmit the instruction to a media engine.

17. The system of claim 16 wherein the user interface is further configured to display a loop menu according to a list received from the media engine, the list comprising a loop identifier.

18. The system of claim 16 wherein the instruction indicates a user identifier.

19. The system of claim 18 wherein the user identifier is associated with a default loop.

20. The system of claim 16 wherein the instruction indicates a command to create the first loop.

21. A method for providing a media, the method comprising:
capturing the media;
receiving a selection of the media, the selection indicating that the media is to be added to a first loop;
generating an instruction comprising a copy of the media and indicating the first loop; and
transmitting the instruction to a media engine.

22. The method of claim 21 further comprising display a loop menu according to a list received from the media engine, the list comprising a loop identifier.

23. The method of claim 21 wherein the instruction indicates a user identifier.

24. The method of claim 23 further comprising associating the user identifier with a default loop.

25. The method of claim 21 wherein the instruction indicates a command to create the first loop.

26. A software product for providing a media, the software product comprising:
software operational when executed by a processor to direct the processor to capture the media, receive a selection of the media, the selection indicating that the media is to be added to a first loop, generate an instruction comprising a copy of the media and indicating the first loop, and transmit the instruction to a media engine; and
a storage medium configured to store the software.

27. The software product of claim 26 the software operational when executed by a processor to direct the processor to display a loop menu according to a list received from the media engine, the list comprising a loop identifier.

28. The software product of claim 26 wherein the instruction indicates a user identifier.

29. The software product of claim 28 the software operational when executed by a processor to direct the processor to associate the user identifier with a default loop.

30. The software product of claim 26 wherein the instruction indicates a command to create the first loop.
